(19) United States
(12) Patent Application Publication
(10) Pub. No.: US 2025/0276674 A1
(43) Pub. Date: Sep. 4, 2025

(54) METHOD FOR OPERATING A MOTOR VEHICLE, COMPUTER PROGRAM PRODUCT, STORAGE MEDIUM, COMPUTER DEVICE

(71) Applicant: Robert Bosch GmbH, Stuttgart (DE)

(72) Inventors: Paul Oborowski, Abstatt (DE); Jan Becker, Backnang (DE); Markus Beisswenger, Schwaebisch Hall (DE)

(21) Appl. No.: 19/065,264

(22) Filed: Feb. 27, 2025

(30) Foreign Application Priority Data
Feb. 29, 2024 (DE) 10 2024 201 865.1

(51) Int. Cl. B60T 8/1761; B60T 8/52; B60W 10/18

(52) U.S. Cl. CPC B60T 8/1761; B60T 8/52; B60W 10/18; B60T 2250/04; B60W 2520/10; B60W 2520/28

(57) ABSTRACT

A method for operating a motor vehicle. The motor vehicle has an axle having a first and a second wheel coupled to one another by a differential gear. The wheels are also assigned a drive apparatus having an activatable first actuator via the differential gear. The first wheel, assigned to a left side of the motor vehicle, is assigned a first wheel braking apparatus having an activatable second actuator, and the second wheel, assigned to a right side, is assigned a second wheel braking apparatus having an activatable third actuator. A torque target value is specified according to a braking request, the first actuator is activated at least according to the torque target value for fulfilling the braking request, and the second and the third actuators are activated according to a difference between an actual speed of the first wheel and an actual speed of the second wheel.

### FIELD

The present invention relates to a method for operating a motor vehicle, wherein the motor vehicle comprises at least one axle having a first and a second wheel, which are coupled to one another by a differential gear, wherein the wheels are also assigned a drive apparatus having an activatable first actuator via the differential gear, wherein the first wheel, which is assigned in particular to a left side of the motor vehicle, is assigned a first wheel braking apparatus having an activatable second actuator, and wherein the second wheel, which is assigned in particular to a right side of the motor vehicle, is assigned a second wheel braking apparatus having an activatable third actuator.

Furthermore, the present invention relates to a computer program product which performs the above method if the computer program product is executed on a computer device. Furthermore, the invention relates to a machine-readable storage medium having such a computer program product and to a computer device that is specifically configured to execute the computer program product or to carry out the above-mentioned method.

### BACKGROUND INFORMATION

It is conventional to use the existing electric drive apparatus or apparatuses in electrically powered motor vehicles together with or instead of the wheel braking apparatuses in order to decelerate the motor vehicle. In particular, this is done within the framework of a slip control system. The aim of a slip control system is to regulate a given target slip on a wheel, in particular by specifying a slip target value or speed target value dependent thereon.

### SUMMARY

In a method according to an example embodiment of the present invention, at least one torque target value is specified according to a braking request, in that the first actuator is activated at least according to the torque target value for fulfilling the braking request, and in that the second and the third actuators are activated according to a difference between an actual speed of the first wheel and an actual speed of the second wheel. The actuators are designed in particular as electrical machines. As already mentioned at the beginning, it is conventional to integrate the actuator of an electric drive apparatus into a slip control system in various ways. In accordance with the present invention, a target torque is specified as a torque target value for the actuator during braking. In particular, a speed limit value is also specified as a minimum speed. A control device assigned to the actuator then has the task of automatically reducing the target torque if the minimum speed is not reached, until an actual speed of the axle, in particular the average value of the actual speed of the first wheel and the actual speed of the second wheel, corresponds to the minimum speed, or the target torque is reduced again. One challenge here is the coordination of the actuator of the drive apparatus and the actuators of the wheel braking apparatuses. The method according to the invention is based on the case in which the motor vehicle has a drive apparatus that is coupled to both wheels via a differential gear, so that a total of three actuators act on two wheels, which represents an overdetermined system and requires coordination of the inherent redundancy. For this purpose, the method according to the invention provides an advantageous control structure, in which the drive apparatus is activated according to the torque target value, in particular also according to the speed limit value as a minimum speed, and the wheel braking apparatuses are activated according to a differential speed. Due to the wheel braking devices, a speed is controlled to the extent that it corresponds to the difference in the speed of the left and right wheels. If the first actuator of the drive apparatus has sufficient torque available, the wheel control task on homogeneous friction values (for example on ice and snow) is effected under the assumption that both wheels have approximately the same wheel speed, completely via the first actuator by control of the axle speed resulting from the use of the differential gear. However, in the case of inhomogeneous friction values between the left and right sides (for example u-split), control purely via the axle speeds with an open axle differential or a low degree of locking of the axle differential is not sufficient, since the average speed is mainly determined by the wheel having the lower friction value, while the wheel having the higher friction value runs very stably. In this case, the vehicle does not decelerate optimally. In this case, the advantages of the method according to the invention come into play, as the actuator of the wheel braking apparatus is automatically activated based on the resulting differential speed in order to provide an additional braking torque, which is regulated via the wheel braking apparatuses, in addition to the braking torque generated by means of the first actuator. Advantages of the method according to the present invention include improved handling in u-split situations, an adjustable yaw response of the vehicle through the explicit control of the wheel differential speed, and a more precise control of the wheel speeds by avoiding switching on and off to other controller architectures.

According to a preferred further development of the present invention, the first actuator is activated according to an average value of the actual speed of the first wheel and the actual speed of the second wheel. As a result, an advantageous speed control is ensured, in which the actuator controls an axle speed that corresponds to the average value of the wheel speeds, as already indicated above. The advantage of this architecture, i.e., the combination of speed control via the axle speed with speed control via the wheel speeds, is a direct allocation of the degrees of freedom of the wheels to the corresponding actuators. This also advantageously eliminates the need for additional control loops and logic to condition the actuators against one another. A further advantage of this architecture is that the two speed control loops do not influence one another. The axle speed corresponds to the average speed of the wheels due to the behavior of an open differential under the related art. In turn, the change in axle speed has no effect on the difference in wheel speeds. As a result, an advantageous decoupling is achieved, and the two control loops can be adjusted independently of one other.

According to an example embodiment of the present invention, particularly preferably, the second and the third actuators are only activated if the difference exceeds a specified value. As a result, the robustness of the method according to the invention is advantageously further increased. The initial attempt is thus to fulfill the braking request exclusively via the drive apparatus and to avoid the use of wheel braking devices. Only if a corresponding differential speed results is at least one of the actuators of the wheel braking devices additionally activated, for example in order to brake one of the wheels and reduce the difference.

According to a preferred further development of the present invention, at least one speed limit value is specified according to a braking request, and at least one of the actuators, in particular the first actuator, is activated according to the speed limit value. Due to the speed limit value, it is advantageously ensured that, in each case, a minimum speed is specified for the particular wheel, in order to prevent the wheel from locking and to keep the motor vehicle stable during braking.

Particularly preferably, at least two different torque target values are specified, in particular a first torque target value for the first actuator and a second torque target value for the second and third actuators, and the particular actuator is activated according to the particular specified torque target value. By specifying separate torque target values, the advantage arises that the drive apparatus and wheel braking apparatuses are optimally integrated into the control task.

According to a preferred further development of the present invention, a maximum value is specified for a gradient of a temporal progression of a torque that can be generated or is generated by at least one of the actuators, in particular the second and the third actuators respectively. By specifying the corresponding maximum value of the gradient, it is advantageously ensured that an excessive yaw torque acting on the motor vehicle is safely avoided when the wheel braking devices are used. If the corresponding second and/or third actuator is activated, as described above, for example within the framework of a u-split situation for generating an additional braking torque, the resulting yaw torque is limited by specifying the maximum value for the gradient, which occurs in particular if the wheels are braked differently or the wheel braking devices are activated differently. This advantageously counteracts the build-up of the yaw torque, allowing a driver to steer against it.

According to an example embodiment of the present invention, particularly preferably, at least one torque limit value for one of the actuators, in particular for the second and the third actuators respectively, is specified as a minimum value for a torque that can be generated or is generated by the particular actuator, and the particular actuator is activated according to the specified torque limit value. By specifying the corresponding torque limit value as a minimum value, the advantage arises that a sufficient braking effect is always ensured. If the actuator of the drive apparatus does not provide sufficient torque, for example for a speed control of the axle, the braking torque on both wheels is increased simultaneously via the torque limit value for the actuators of the wheel braking apparatuses as a base adjustment.

According to a preferred further development of the present invention, the torque target value, speed limit value and/or torque limit value are specified by a central control apparatus, and/or each of the actuators is assigned its own control apparatus, in particular one that is connected in each case to the central control device in terms of communication technology, wherein each of the actuators is activated by the control device assigned to it in each case. By specifying a central control apparatus, the advantage arises that the target values and/or limit values are specified upstream and are valid for all actuators. If an independent control device is used for each of the actuators, the advantage arises that the actuators can always be activated safely and independently of one another. The combination of a central control apparatus and respective independent control devices is particularly advantageous, so that the central control apparatus specifies the target values and/or limit values and passes them on to the control devices via a communication connection, so that the control task lies with the control devices.

A computer program product according to the present invention for execution on a computer device performs the method according to the present invention when used as intended. This results in the advantages already mentioned.

A machine-readable storage medium according to the present invention has the computer program product stored thereon according to the present invention.

The computer device according to an example embodiment of the present invention is characterized in that the computer device is specifically configured to execute the computer program product according to the invention or to carry out the method according to the present invention. This also results in the advantages already mentioned above. Preferably, the computer device is a control apparatus and/or control device assigned to a motor vehicle, in particular arranged in the motor vehicle.

For example, a corresponding motor vehicle comprises at least one axle having a first and a second wheel, which are coupled to one another by a differential gear, wherein the wheels are also assigned a drive apparatus having an activatable first actuator via the differential gear, wherein the first wheel, which is assigned in particular to a left side of the motor vehicle, is assigned a first wheel braking apparatus having an activatable second actuator, and wherein the second wheel, which is assigned in particular to a right side of the motor vehicle, is assigned a second wheel braking apparatus having an activatable third actuator, and is characterized by at least one computer device according to the invention designed as a central control apparatus and/or a computer device according to the invention designed as a control device assigned to at least one of the actuators. This results in the advantages already mentioned.

Further preferred features and combinations of features result from what was described above and the rest of the disclosure herein. The present invention is explained in more detail below with reference to the figures.

### BRIEF DESCRIPTION OF THE DRAWINGS

FIG. 1 shows a method for operating the motor vehicle, according to an example embodiment of the present invention.

FIG. 2 shows progression diagrams during the method according to an example embodiment of the present invention.

### DETAILED DESCRIPTION OF EXAMPLE EMBODIMENTS

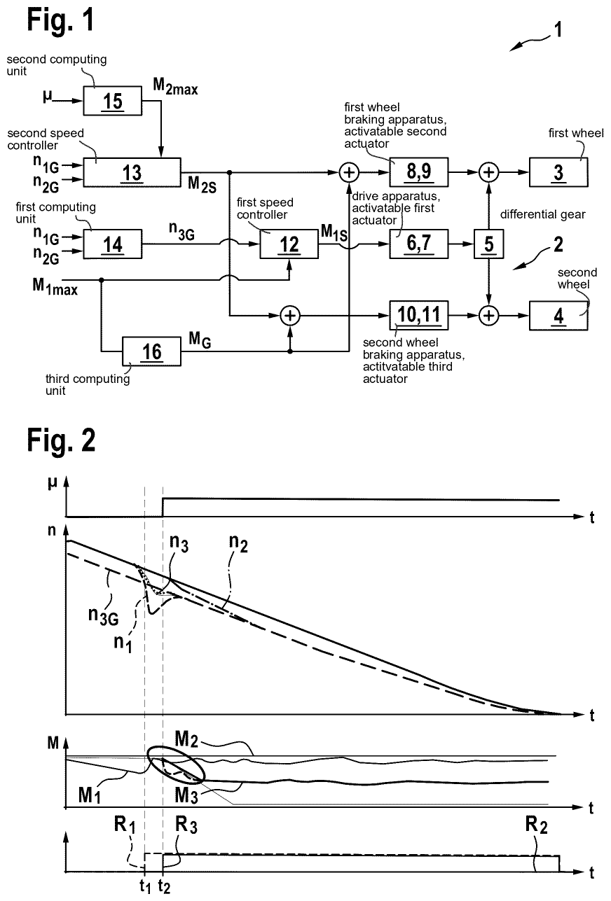

FIG. 1 schematically shows components of a motor vehicle 1 and how they are activated within the framework of an advantageous method or how they are integrated into an advantageous control structure that is used within the framework of the method. In particular, the method ensures that an optimal slip control is carried out in every driving situation.

The motor vehicle 1 comprises at least one axle 2 having a first wheel 3 and a second wheel 4, which are coupled to one another by a differential gear 5. The wheels 3, 4 are also assigned a drive apparatus 6 having an activatable first actuator 7 via the differential gear. For example, the axle 2 is a front axle or a rear axle. It is also possible to provide the structure shown in each case for both a front axle and a rear axle, for example in all-wheel drive motor vehicles.

The first wheel 3, which is assigned in particular to a left side of the motor vehicle 1, is further assigned a first wheel braking apparatus 8 having an activatable second actuator 9. The second wheel 4, which is assigned in particular to a right side of the motor vehicle 1, is assigned a second wheel braking apparatus 10 having an activatable third actuator 11. The actuators 7, 9, 11 are preferably designed as electrical machines in each case. The actuators 9, 11 are alternatively hydraulic actuators, in particular as part of a standard hydraulic friction braking system.

A first speed controller 12 is assigned to the first actuator 7. The second actuator 9 and the third actuator 11 are assigned a common second speed controller 13, which are in particular in each case part of a control device assigned to the particular actuator. The actual method, in which the two speed controllers 12, 13 are used, works as follows:

Initially, according to a braking request, a first speed limit value n_{1G} for the wheel speed of the first wheel 3 and a second speed limit value n_{2G} for the wheel speed of the second wheel 4 are specified, for example, by means of a central control apparatus. From this, an average value is ascertained by means of a first computing unit 14 as a third speed limit value n_{3G} for an axle speed of axle 2 and passed on as an input variable to the first speed controller 12.

A first maximum torque value M₁ₘₐₓ of the maximum torque that can be generated by the first actuator 7 is used as an additional input variable for the first speed controller 12. From the mentioned input variables, a first torque target value M_{1S} for the first actuator 7 is now specified by means of the first speed controller 12.

The first actuator 7 is then activated for fulfilling the braking request according to the first torque target value M_{1S} and according to an average value of the first actual speed n₁ of the first wheel 3 and the second actual speed n₂ of the second wheel 4.

The first speed limit value n_{1G} and the second speed limit value n_{2G} are also used as input variables for the second speed controller 13. A second maximum torque value M₂ₘₐₓ of a maximum torque that can be generated by the second and/or the third actuators 9, 11 and/or a maximum value for a gradient of a temporal progression of a torque that can be generated or is generated by the second and/or the third actuators 9, 11 is used as a further input variable, which is ascertained by means of a second computing unit 15 according to a friction value u.

From the mentioned input variables, a second torque target value M_{2S} is specified for the second and third actuators 9, 11 by means of the second speed controller 13. According to the first maximum torque value M₁ₘₐₓ, by means of a third computing unit 16, a torque limit value M_{G}, in particular a common one, for the second and third actuators 9, 11 is ultimately specified as a minimum value for the torque that can be or is generated by the particular actuator 9, 11. A sum is now formed from the second torque target value M_{2S} and the torque limit value M_{G}.

For fulfilling the braking request, the second and third actuators 9, 11 are additionally activated according to the mentioned sum and according to a difference between the first actual speed n₁ of the first wheel 3 and the second actual speed n₂ of the second wheel 4. The corresponding difference is preferably already taken into account when ascertaining the second torque target value M_{2S}, so that if the difference is zero or in particular does not exceed a specified value, the second torque target value M_{2S} is also zero. The braking request is then fulfilled exclusively by activating the first actuator 7.

By specifying the torque limit value M_{G}, it is ensured that the performance capability of the first actuator 7 is taken into account, and that the second or third actuator 9, 11 is at least activated with the torque limit value if the first maximum torque value M₁ₘₐₓ is not sufficient to fulfill the braking request.

In FIG. 2, progression diagrams over time t are also plotted, which depict the resulting profiles of speeds and torques, in particular, during the process. The exemplary embodiment shown refers to a u-split situation.

In a first of four diagrams, a binary recognition of such a μ-split situation is plotted. In a second of the four diagrams, different speed curves are plotted, namely the first actual speed n₁ of the first wheel 3, the second actual speed n₂ of the second wheel 4, and the third actual speed n₃ of the axle 2, along with the third speed limit value n_{3G} for the axle speed of the axle 2.

In a third of the four diagrams, different torque curves are plotted, namely a first actual torque M₁ of the first actuator 7, a second actual torque M₂ of the second actuator 9, and a third actual torque M₃ of the third actuator 11, along with the second maximum torque value M₂ₘₐₓ of the maximum torque that can be generated by the second and/or third actuators 9, 11. Finally, in the fourth, lower diagram of the four diagrams, it is also plotted in binary form when a corresponding speed control is active by means of the corresponding speed controllers 12, 13 of the actuators, namely a first control R₁ of the first actuator 7, a second control R₂ of the second actuator 9 and a third control R₃ of the third actuator 11. The corresponding control becomes active in particular if the corresponding speed does not reach its limit value.

At the beginning, all actual speeds n₁, n₂, n₃ are above their respective limit values, in particular the third actual speed n₃ is above the third speed limit value n_{3G}. An actual torque M₁ is only set by the first actuator 7 of the drive apparatus. The first actual speed n₁ then does not reach its limit value and, with a slight deceleration, the third actual speed n₃ dependent thereon also falls below its limit value at a first point in time t₁.

The first control R₁ of the first actuator 7 is now started, and the actual torque M₁ is reduced. Since a difference between the actual speeds n₁ and n₂ results, a μ-split situation is recognized at a second point in time t₂, wherein the progression shown in the top diagram changes to logical 1 accordingly.

The control R₃ of the third actuator 11 then also begins at the second point in time t₂ in order to brake the second wheel 4 and reduce the difference. Both the second actual torque M₂ as well as the second control R₂ remain at zero, so the second actuator is not activated.

Accordingly, a braking torque is set in the form of the third actual torque M₃. As a result, the wheel speeds are brought closer together, and the difference is controlled to or near zero. Given that, as described above, both its maximum value and its gradient are limited to prevent excessive yaw torque, the resulting solid-line curve arises. Without the corresponding limitation, the dashed and circled curve would arise after the point in time t₂.

1-11. (canceled)

12. A method for operating a motor vehicle, the motor vehicle including at least one axle having a first wheel and a second wheel, which are coupled to one another by a differential gear, the first and second wheels are assigned a drive apparatus having an activatable first actuator via the differential gear, wherein the first wheel, which is assigned a left side of the motor vehicle, is assigned a first wheel braking apparatus having an activatable second actuator, and the second wheel, which is assigned to a right side of the motor vehicle, is assigned a second wheel braking apparatus having an activatable third actuator, the method comprising the following steps:
specifying at least one torque target value according to a braking request;
activating the first actuator at least according to the torque target value for fulfilling the braking request; and
activating the second and the third actuators according to a difference between an actual speed of the first wheel and an actual speed of the second wheel.

13. The method according to claim 12, wherein the first actuator is activated according to an average value of the actual speed of the first wheel and the actual speed of the second wheel.

14. The method according to claim 12, wherein the second and the third actuators are activated only when the difference exceeds a specified value.

15. The method according to claim 12, wherein at least one speed limit value is specified according to the braking request, and the first actuator is activated according to the speed limit value.

16. The method according to claim 12, wherein at least two different torque target values are specified, the at least two different torque targe values including a first torque target value for the first actuator and a second torque target value for the second and third actuators, wherein and the first actuator is activated according to the first torque target value and the second and third actuators are activated accounting to the second torque target value.

17. The method according to claim 15, wherein a maximum value is specified for a gradient of a temporal progression of a torque that can be generated or is generated by the second and the third actuators respectively.

18. The method according to claim 15, wherein at least one torque limit value for the second and the third actuators, respectively, is specified as a minimum value for a torque that can be generated or is generated by the second and the third actuators, respectively, and the second and third actuators areas activated according to the respective torque limit value.

19. The method according to claim 18, wherein: (i) the torque target value, and/or the speed limit value and/or the torque limit value are specified by a central control apparatus, and/or (ii) each of the first, second, and third actuators is assigned its own respective control device, each connected to the central control apparatus in terms of communication technology, wherein each of the first, second, and third actuators is activated by the respective control device assigned to it in each case.

20. A non-transitory machine-readable storage medium on which is stored a computer program for operating a motor vehicle, the motor vehicle including at least one axle having a first wheel and a second wheel, which are coupled to one another by a differential gear, the first and second wheels are assigned a drive apparatus having an activatable first actuator via the differential gear, wherein the first wheel, which is assigned a left side of the motor vehicle, is assigned a first wheel braking apparatus having an activatable second actuator, and the second wheel, which is assigned to a right side of the motor vehicle, is assigned a second wheel braking apparatus having an activatable third actuator, the computer program, when executed by a computer, causing the computer to perform the following steps:
specifying at least one torque target value according to a braking request;
activating the first actuator at least according to the torque target value for fulfilling the braking request; and
activating the second and the third actuators according to a difference between an actual speed of the first wheel and an actual speed of the second wheel.

21. An electronic control device for a motor vehicle, the electronic control device configured to operate a motor vehicle, the motor vehicle including at least one axle having a first wheel and a second wheel, which are coupled to one another by a differential gear, the first and second wheels are assigned a drive apparatus having an activatable first actuator via the differential gear, wherein the first wheel, which is assigned a left side of the motor vehicle, is assigned a first wheel braking apparatus having an activatable second actuator, and the second wheel, which is assigned to a right side of the motor vehicle, is assigned a second wheel braking apparatus having an activatable third actuator, the electronic control device configured to:
specify at least one torque target value according to a braking request;
activate the first actuator at least according to the torque target value for fulfilling the braking request; and
activate the second and the third actuators according to a difference between an actual speed of the first wheel and an actual speed of the second wheel.
